(19) United States
(12) Patent Application Publication
(10) Pub. No.: US 2010/0231162 A1
(43) Pub. Date: Sep. 16, 2010

(54) SOLAR POWERED BATTERY CHARGING METHODS AND DEVICES FOR LITHIUM-ION BATTERY SYSTEMS

(75) Inventors: Thomas L. Gibson, Washington Township, MI (US); Nelson A. Kelly, Sterling Heights, MI (US); David B. Ouwerkerk, Torrance, CA (US)

Correspondence Address: General Motors Corporation;c/o REISING ETHINGTON P.C., P.O. BOX 4390, TROY, MI, 48099-4390, US

(73) Assignee: GM GLOBAL TECHNOLOGY OPERATIONS, INC., DETROIT, MI (US)

(21) Appl. No.: 12/696,339

(22) Filed: Jan. 29, 2010

Related U.S. Application Data
(60) Provisional application No. 61/160,460, filed on Mar. 16, 2009.

(51) Int. Cl. H01M 10/46; H02J 7/00

(52) U.S. Cl. 320/101; 320/117; 180/65.29

(57) ABSTRACT

Exemplary embodiments include methods and devices for storing and recovering renewable solar (photovoltaic) energy in batteries by using circuits that automatically connect batteries in parallel during charging and in series when discharging and to build battery strings that automatically resist overcharging and excessive discharging. Other embodiments may include methods for optimizing the efficiency of solar charging by varying the number of battery cells in series to match the battery voltage to the photovoltaic maximum power point voltage.

This Application claims the benefit of U.S. Provisional Application Ser. No. 61/160,460 filed Mar. 16, 2009.

### TECHNICAL FIELD

The field to which the disclosure generally relates to includes solar powered battery charging methods and devices for lithium-ion battery systems.

### BACKGROUND

Extended-Range Electric Vehicles (E-REV) such as the Chevy Volt and Plug-In Hybrid Vehicles (PHEV) allow daily commuting powered by electricity without burning fossil fuels on board. They can provide greater environmental benefits including eliminating green house gases if their batteries are charged using renewable sources of electricity to replace grid power generated mainly by coal and other fossil fuel combustion. A potentially efficient way to use renewable energy is to supply direct current from photovoltaic (PV) modules to the battery system.

It is known that lithium ion cells are sensitive to overcharging, heat generation, cell damage, shortened lifetimes, and safety risks when the cell strings and battery modules are combined and charged in battery packs. To address this problem, centralized charge controllers with smart circuitry may need to be connected to all of a hundred or more units (cells or modules) within the pack to level the charge and voltages in all individual cells.

### SUMMARY OF EXEMPLARY EMBODIMENTS OF THE INVENTION

One embodiment includes a product comprising a plurality of battery cells or modules and relays connected thereto and arranged to charge the battery modules or cells in parallel and discharge the battery modules or cells in series.

Other exemplary embodiments of the invention will become apparent from the detailed description provided hereinafter. It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

Exemplary embodiments of the invention will become more fully understood from the detailed description and the accompanying drawings.

FIG. 1. A simplified solar battery charger using multiple pole double throw (MPDT) relays for contactors to allow charging battery cells and modules in parallel and discharging them in series. Here, a battery module is defined as one or more cells connected in series. Three battery modules or cells are shown in the FIG. 1 for illustrative purposes, but the actual number is expected to be much greater. The relays would control battery modules of 10-16 cells to level the cell charges. The battery modules may also be protected by using temperature actuated switches and diodes to help level cells and avoid exceeding the correct operating range of the batteries.

FIG. 2. Detail of the multiple pole double throw (MPDT) relay used to switch cells from parallel connection to series connection.

FIG. 3. Schematic of a solar powered battery charging circuit with a temperature actuated switch to bypass a cell that heated due to overcharging.

FIG. 4. Schematic of an alternative solar powered battery charging circuit that uses zener or avalanche diodes to bypass any cell that exceeds the desired set point voltage.

FIG. 5. Schematic of a battery discharge circuit with a voltage actuated switch to bypass a cell that is discharged to its desired minimum voltage (frequently 2.0-2.5 volts).

FIG. 6. Schematic of a battery discharge circuit with a charge actuated switch to bypass a cell that is discharged to its desired minimum state of charge, SOC, (frequently 50%).

FIG. 7. Schematic of a solar powered battery discharging circuit with diodes to bypass any cell that is completely discharged to prevent polarity reversal at some individual cells (“flipping”).

FIG. 8. Optimization of solar powered battery charging by matching the MPP of the PV system and the charge voltage of the battery module by varying the number of Li-Ion cells wired in series.

### DETAILED DESCRIPTION OF EXEMPLARY EMBODIMENTS

The following description of the embodiment(s) is merely exemplary (illustrative) in nature and is in no way intended to limit the invention, its application, or uses.

Embodiments include methods and devices to maintain voltage leveling and charge leveling of all cells in a battery module.

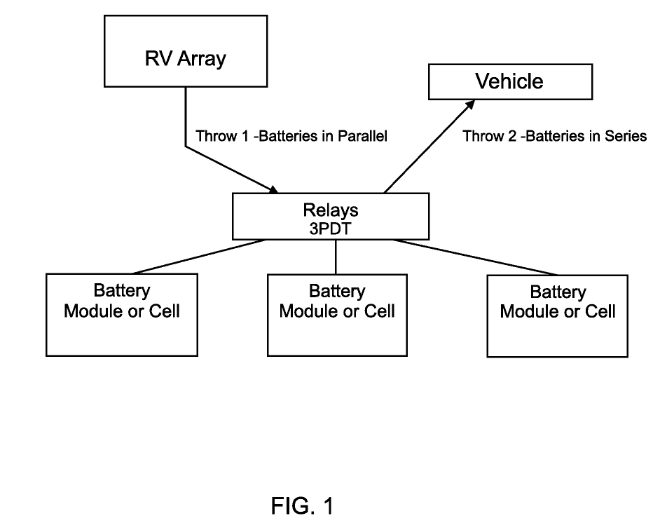

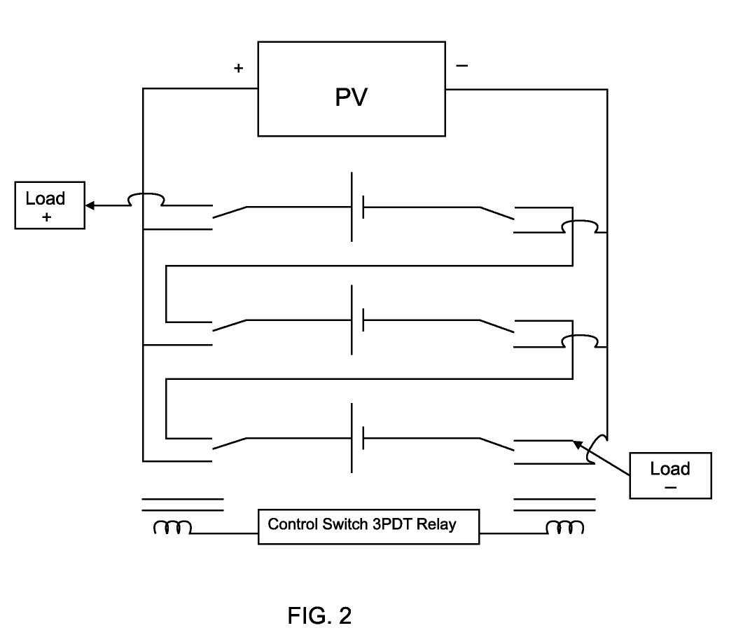

A battery module consists of at least one battery cell, such as a lithium ion (Li Ion) cell. All the individual cells used for a battery module are of identical type and are individually charged to about the same voltage and SOC before being used. All the cells are electrically connected in parallel during charging and also after charging during storage so that their cell voltages and cell SOC are all equal. The cells are then connected by relays (example: MPDT relays, i.e., solenoid switches) so that they can be switched from parallel to series configuration to form a battery module when the module is connected to a load (example: a module with 15 Li-Ion cells in parallel and a potential of 3.3 volts DC is switched to form a battery module with 15 cells in series and a potential of 50 volts.) Three cells or modules are shown in the figure, but this invention is intended to cover any number of cells or modules. See FIGS. 1 and 2.

Another embodiment includes methods and devices to maintain voltage leveling and charge leveling of all cells and modules in an entire battery pack.

A battery module consists of at least one battery cell, such as a lithium ion (Li Ion) cell. All the individual cells used for a battery module are of identical type and are individually charged to about the same voltage and SOC before being used. All the cells are electrically connected in parallel during charging and also after charging during storage so that their cell voltages and cell SOC all remain equal. The modules are then connected by relays (example: MPDT relay, i.e., solenoid switches) so that they can be switched from parallel to series configuration to form a battery pack when the modules are connected to a load such as an electric vehicle power train (example: A group of 7 modules in parallel each with 15 Li-Ion cells in series and a potential of 50 volts DC are switched to form a battery pack with the 7 modules in series and a potential of 350 volts.) Three cells or modules are shown in the figure, but this invention is intended to cover any number of cells or modules. See FIGS. 1 and 2.

Another embodiment includes a method to prevent overcharging of battery cells in battery modules and battery packs, i.e. exceeding the maximum desired or allowable charge voltage. To prevent overcharging of any battery cell in a series string due to starting with a higher initial state of charge (SOC) in a cell or a lower initial capacity in a cell.

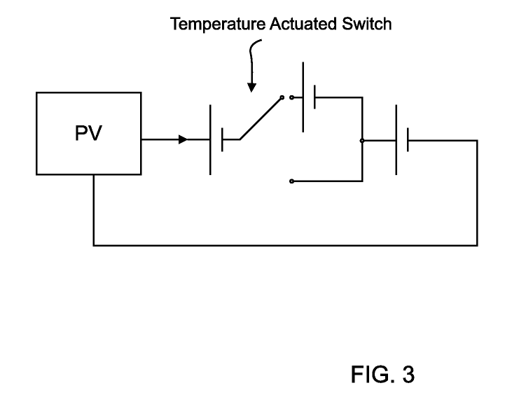

Each cell in a series string (i.e., module) of Li-Ion cells is fitted with a temperature actuated switch connected to a sensor on the skin of the cell. Whenever the cell temperature rises above a set temperature, such as the maximum allowable cell temperature (85° C.) due to heat formed by overcharging, the switch bypasses the cell by disconnecting the cell from the string and electrically coupling the two adjacent cells. See FIG. 3.

Another embodiment includes a method to prevent overcharging of battery cells in battery modules and battery packs, i.e. exceeding the maximum desired or allowable charge voltage. An alternative method to prevent overcharging of any battery cell in a series string due to starting with a higher initial state of charge (SOC) in a cell or a lower initial capacity in a cell.

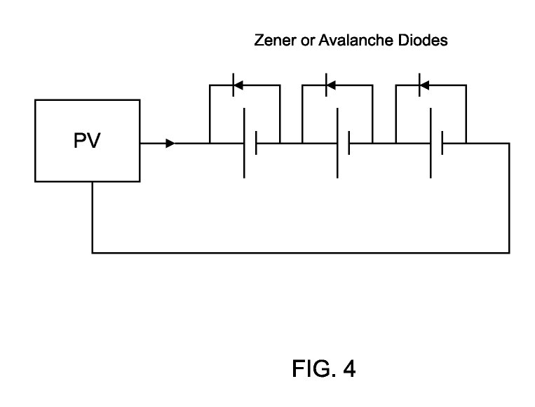

Each cell in a series string (i.e., module) of Li-Ion cells is fitted with a Zener or avalanche diode connected to the two poles of the cell with the low-voltage polarity of the diode opposite to the polarity of the cell. The Zener or avalanche diode is designed to break down at a specific reverse voltage V_{b} designed to be between the desired set point voltage and the maximum allowable voltage of a fully charged cell. This V_{b} could be at the maximum recommended charge voltage, sometimes 3.8 volts. Whenever the cell voltage rises above the desired set point voltage to V_{b}, the diode bypasses the cell by electrically coupling the two adjacent cells and allowing current to flow through the Zener or avalanche diode in its reverse direction. This current will then continue to charge all other cells in the series string that have not yet reached the set point voltage. See FIG. 4.

Another embodiment includes a method to prevent excessive discharge of battery cells, battery modules, and battery packs, i.e., prevent going below the minimum desired or allowable voltage and minimum allowable charge.

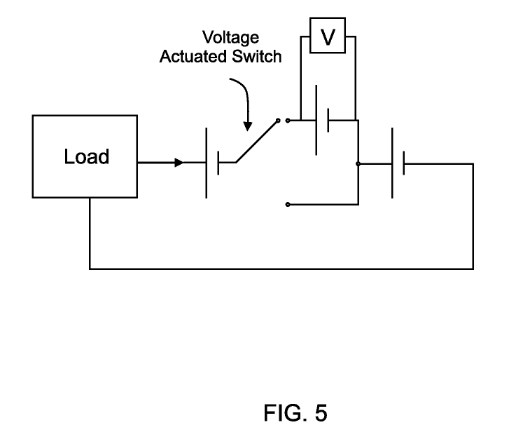

Each cell in a series string (i.e., module) of Li-Ion cells that will be discharged is fitted with a diode or voltage activated switch connected to the two poles of the cell. Whenever the voltage drop across the cell falls below a set voltage (such as the recommended cell cutoff voltage (2.0 V), the switch bypasses the cell by disconnecting the cell from the string and electrically coupling the two adjacent cells. See FIG. 5.

Another embodiment includes a method to prevent excessive discharge of battery cells, battery modules, and battery packs, i.e., to prevent going below the minimum desired state of charge.

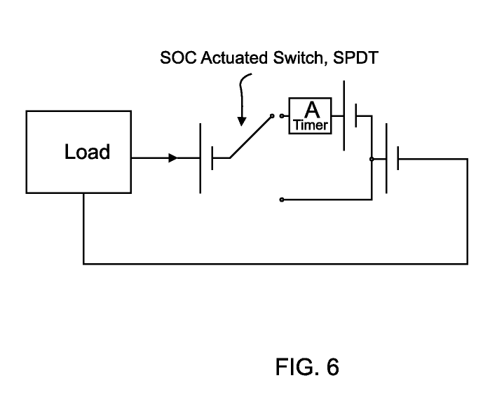

Each cell in a series string (i.e., module) of Li-Ion cells that will be discharged is fitted with a charge actuated switch connected to the two poles of the cell. The decrease in state of charge is estimated by measuring the current and time during discharge of the cells. When a set discharge has occurred, equal to a predetermined % of the full charge (often set at 1.15 Ah, i.e., 50% SOC), the switch bypasses the cell by disconnecting the cell from the string and electrically coupling the two adjacent cells. See FIG. 6.

Another embodiment includes a method to prevent polarity reversal, i.e. “flipping” of any battery cell in a series string due to excessive discharging of a cell.

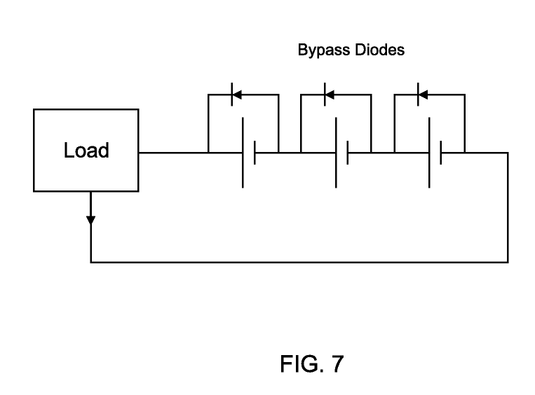

An individual cell in a series string can have a lower initial state of charge (SOC) or lower initial capacity causing it to become completely discharged during the process of discharging the string. The flow of current from other cells through the discharged cell can then reverse its polarity (“flipping”) causing chemical reaction and damage within the cell. To prevent this, each cell in a series string (i.e., module) of Li-Ion cells is fitted with a bypass diode (e.g., a Schottky or silicon diode) connected to the two poles of the cell. Whenever the correctly (positively) biased voltage drop across any cell might fall to zero during the process of discharging the string, the bypass diode will automatically carry the current flowing from the other cells around the affected cell (a bypass), thereby, preventing polarity reversal of the affected cell in which current could flow in the wrong direction. The switch bypasses the cell by disconnecting the cell from the string and electrically coupling the two adjacent cells. See FIG. 7.

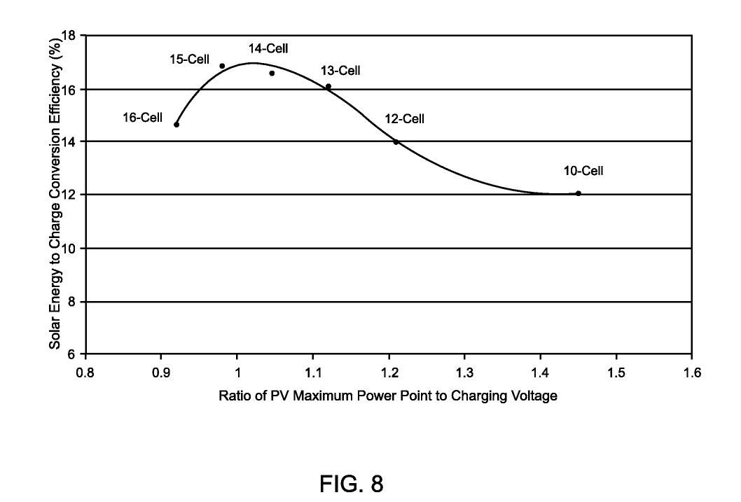

Another embodiment includes a method to optimize the efficiency of a solar powered battery charger consisting of a photovoltaic (PV) system electrically connected to a lithium ion (Li-Ion) battery system by determining the maximum power point (MPP) voltage of the PV solar cells and the optimum charge voltage of the Li-Ion battery cells and connecting specific numbers of solar cells in series with the Li-Ion cells in series so that under operating conditions, the overall MPP voltage of the PV system matches or is slightly less than the overall optimum charging voltage of the Li-Ion battery module. We have tested a PV system consisting of Sanyo HIP-190BA3 photovoltaic modules with a specific MPP voltage of approximately 50 V under the usual operating conditions (52° C.) connected in series to various numbers of A123 Iron phosphate type Li-Ion cells. The series strings consisted of 12, 13, 14, 15, and 16 cells. The highest efficiency of solar energy to battery charge conversion occurred for 15 cells, a voltage ratio of V_{MPP} from the PV system to the charging voltage of the battery module equal to 1.0. The efficiency was optimized at 16-17% by matching the V_{MPP} of the PV system to the charging voltage of the battery module (sometimes called the “sweet spot”). See FIG. 8.

The above description of embodiments of the invention is merely exemplary in nature and, thus, variations thereof are not to be regarded as a departure from the spirit and scope of the invention.

What is claimed is:

1. A product comprising a plurality of battery cells or modules and a plurality of relays connected thereto and constructed and arranged to charge the battery cells or modules in parallel and discharge the battery cells or modules in series.

2. A product as set forth in claim 1 further comprising a temperature actuated switch connected to a sensor on the outer surface of at least one of the battery modules or cells and the switch being constructed and arranged to bypass the cell by disconnecting the cell from adjacent cells should the temperature of the cell exceed a predetermined value.

3. A product as set forth in claim 1 further comprising a zener or avalanche diode connected to two poles of one of the battery modules or cells with the low-voltage polarity of the diode opposite to the polarity of the cell.

4. A product as set forth in claim 1 further comprising a diode or voltage activated switch connected to two poles of one of the cells and constructed and arranged so that whenever the voltage drop across the cell falls below a set voltage the diode or switch bypasses the cell by disconnecting the cell from adjacent cells.

5. A product as set forth in claim 1 further comprising a charge actuated switch connected to the poles of at least one of the battery modules or cells and constructed and arranged to bypass the battery module or cell by disconnecting the same from adjacent battery modules or cells when a set discharge has occurred equal to a predetermined percentage of the full charge for the battery module or cell.

6. A product as set forth in claim 1 further comprising a bypass diode connected to the poles of at least one of the battery modules or cells and constructed and arranged so that whenever the biased voltage drop across any cell may fall to zero during the process of discharging the plurality of battery modules or cells, the bypass diode will automatically carry the current flowing from other cells around the effected cells, thereby preventing polarity reversal of the effected cell in which the current could flow in the wrong direction.

7. A product as set forth in claim 1 wherein the photovoltaic system is electrically connected to a lithium ion battery system for determining the maximum power point voltage of the photovoltaic solar cells and the optimum charge voltage of the lithium ion battery cells and connecting a specific number of solar cells in series with the lithium ion cells in series so that under operating conditions, the maximum power point voltage of the photovoltaic system matches or is slightly less than the overall optimum charging voltage of the lithium ion battery module.
